(19) United States
(12) Patent Application Publication
(10) Pub. No.: US 2009/0230592 A1
(43) Pub. Date: Sep. 17, 2009

(54) Laser-Perforated Skin Substitute

(76) Inventor: Aubrey Woodroof, Calsbad, CA (US)

Correspondence Address: STEVEN W. WEBB, 825 College Blvd., Suite 102620, Oceanside, CA, 92057, US

(21) Appl. No.: 12/049,321

(22) Filed: Mar. 15, 2008

(51) Int. Cl. B29C 71/04; B29C 35/02; B29C 71/00

(52) U.S. Cl. 264/400; 264/239

(57) ABSTRACT

The Temporary Skin Substitute of this invention consists of three components: The top component is a thin (approximately 0.001″ thick) silicone elastomer in which laser holes have been drilled; physically attached to the silicone elastomer is a fine knitted nylon fabric (12/1, 15/1 denier); incorporated into the silicone/nylon structure are collagen peptides [about 10 micrograms per square centimeter of Porcine type 1—“the active component”] without cross-linking agent to enable a quick interaction with fibrin in the wound to achieve acute adherence. The laser drilled holes provide a wide range of porosity to ensure minimum fluid accumulation beneath the Temporary Skin Substitute without wound desiccation. The range of hole diameters preferred in the present invention is 0.75 mm to 1.05 mm and at holes centered at ¼″-⅓″. Providing a structure that has better acute adherence and minimal fluid accumulation beneath the Temporary Skin Substitute, which will reduce infection complications and maximize wound healing. Larger pieces of this skin substitute can be made to cover larger wounds, unlike previous skin substitutes.

### FIELD OF THE INVENTION

This invention relates to a new and improved laser-perforated, multi-direction stretchable (100% in any direction) silicone/nylon composite to which collagen peptides (“active component”) can readily interact with fibrin present in the wound to achieve acute adherence. The laser perforations enable Temporary Skin Substitutes to be fabricated with a wide range of pore size and pore densities. This enables the clinician to effectively manage wounds that have widely variable amounts of exudates (wound secretions) while minimizing the accumulation of exudates beneath the temporary skin substitute. The exudates can be transmitted through the pores into a sterile adsorptive outer dressing, thus minimizing the proliferation of endogenous bacteria on the wound surface.

### BACKGROUND OF THE INVENTION

This inventor has received a patent for a previous version of this invention, U.S. Pat. No. 4,828,561. The present application concerns a substantially modified version of the previous invention, with substantially different utility, as will be shown.

Numerous prior patents have published concerning both Temporary (without living cells) and Permanent Skin Substitutes (may contain a variety of living cell types), and these include: U.S. Pat. Nos. 4,617,186; 4,673,649; 4,820,302; 4,828,561; 4,985,036; 5,501,959; 5,282,859; 5,830,507; 6,562,358; 6,627,215; 6,846,490; US 2003/022,5355 A1: US 2004/008,6479 A1: and, Reissue 35,399. U.S. Pat. Nos. 4,820,302 and 4,828,561 have issues to the inventor, herein.

However, none of these patents disclose the use of laser-formed perforations and many of these patents utilize cross-linking agents to attach a biologically active component (collagen, collagen peptide, glycosaminoglycan, etc.), to the skin substitute.

As well, none of the above patents disclose the importance of greater porosity to minimization of fluid accumulation beneath the skin substitute. Reduced fluid accumulation under such skin substitutes results in reduced infection rates for the covered wound.

The 10 micrograms/cm² collagen peptide of this invention is applied with airbrush to the nylon surface in a manner to enable it to more freely interact with fibrin in the wound. Cross-linking agents immobilize collagen peptides, which reduces its ability to move and interact with fibrin. Residual cross-linking agent dodecylamine in the silicone elastomer are known to cause pyrogenic/allergenic reactions.

One problem with needle-perforated skin substitutes is that there is a limited area in which the needles may be arrayed, and this limits the perforation density of the holes to be made.

Secondly, in the case where silicone elastomer is the skin substitute component being perforated, the needles must be applied during the cure cycle, otherwise the holes collapse when the needle is removed from a cured silicone membrane. This process of applying needles during the silicone elastomer cure cycle is very limiting and crude. Another problem with applying needles during the cure cycle is the holes are irregular and frequently the needles tear the nylon fabric. Holes too large (i.e., 1.5 mm diameter or larger when the skin substitute is stretched, which is common) result in punctuate scarring.

An alternate embodiment of the present invention uses needles of various diameters to pierce holes in the new skin substitute after the curing cycle has completed. These holes can be arrayed in a regular or random pattern with centers as close as 1/16 of an inch. The holes do not close up after the piercing process and the strength of the skin substitute piece is not reduced by the process, unlike previous methods taught by the art.

Another benefit of the present invention is the ability to fabricate the skin substitute in larger sizes. This is possible because of knitting technology that makes the nylon component in larger sizes. The size of the nylon component is the key limitation in final product size. Larger skin substitute pieces enable the surgeon to close large wounds quickly without seams. Seams can provide an entry to exogenous bacteria and cause failure of the skin substitute (infection). Shorter operating room time is an obvious cost benefit. The primary benefit of the temporary skin substitute invention is to provide a moist wound healing environment, with minimal fluid accumulation beneath the temporary skin substitute, thus minimizing infection from either endogenous or exogenous bacteria and optimizing the wound healing process.

In addition to the above, materials used as burn dressings and surgical dressings should be bio-and-blood compatible. This especially applies to clean, superficial burns, donor sites, autografts, and excised deep burns. In the case of such dressings, an area in which the present invention finds particular utility, there are additional requirements because of the use of the materials.

As is known in the art, and described in U.S. Pat. No. 3,800,792, treatment of second and third degree burns involves a number of phases, including cleaning and stabilizing the wound area to produce a granulation bed at the wound site. The final phase of treatment is usually the autografting phase which sometimes take place some period of time after development of the granulation bed. The maintenance of the granulation bed is a necessity until such time as autograft is available and successful autografting is completed.

Several different approaches have been used to preserve the wound site, i.e. granulation bed, for example, application of wet dressings which must be changed frequently and tend to add to patient discomfort. Homografts, heterografts and synthetic dressings have also been used.

Accordingly, a wide variety of dressings, characterized as biological and synthetic, have been used in the treatment of burn wounds. Biological dressings include any dressing that has one or more biological components, i.e. protein, carbohydrates, lipids and the like. Presently, homograft and porcine xenograft skin are dressings currently used to maintain the granulation bed.

In burn patients with large areas of burn tissue, the amount of available skin (autograft) is limited and temporary dressings are required for long periods of time to maintain the granulation bed. Homografts (cadaver skin) is the current dressing of choice, when available. Human amniobiotic membrane has also been used but is less desirable than cadaver skin. Lack of availability, short shelf, and the potential for transmission of diseases, such as AIDS and hepatitis, are also drawbacks.

Xenograft (porcine) skin is commercially available but is considerably less effective than homografts and autografts. Short shelf like, sterility and limited application are known disadvantages of this material, in addition to an antigenicity problem.

2. Description of the Prior Art

The previous invention, Biobrane—U.S. Pat. No. 4,828,561, is in wide use around the world as the treatment of choice for fresh superficial burns. It is frequently used for covering and preserving donor sites, protecting widely meshed autografts, until the interstices close, and for protecting an excised, deep burn until autograft is available. The previous invention has all the characteristics and properties of an “ideal temporary skin substitute”, as described in the Biobrane patent.

When Biobrane fails, it is because of

1) a lack of initial adherence to the wound area,

2) fluid accumulation beneath the Biobrane membrane,

3) an allergic reaction to the Biobrane material

In the case of lack of initial adherence to the wound, poor adherence could result from inadequate debridement of necrotic tissue in the wound, blood or exudate accumulation underneath the membrane, or any other occlusive or semi-occlusive skin substitute, or improper immobilization of the Biobrane with a pressure dressing during the initial 24 hour treatment period.

Fluid accumulation underneath the membrane is caused by fluid entrapment due to inadequate pore size or pore density—Biobrane has a single-sized hole about 1.6 mm in diameter centered at ½ inch centers. Any fluid accumulation underneath a skin substitute is likely to become infected because bacteria present on the wound proliferate in the fluid incubated at body temperature. Infected areas require “windowing” and treatment with topical anti-microbials, which delay healing.

New laser-based technology permits production of temporary or permanent skin substitutes with a wide range of pore hole diameters and distribution densities. Laser drilling allows pore holes to be placed indefinitely close to each other in a regular or random pattern.

The alternate embodiment of the present method, using needles of various diameters after the curing cycle is complete, also produces a skin substitute with a wide range of pore hole diameters, with hole centers as close as 1/16 of an inch.

The present design, using said laser pore hole drilling in skin substitutes, enables effective early transfer of blood, exudate, and other fluids through the skin substitute and into a sterile outer gauze, or other dressing. elimination of fluid pockets effectively reduces the chances of infection and increases the rate of uniform healing over the entire wound surface. The increased porosity of the new skin substitute due to the improved hole drilling process also aids health care givers in treating the wound with medicines, such as water-soluable antibiotics, to improve healing and manage microbial proliferation.

Allergic reactions of a patient to Biobrane requires immediate removal and discontinued use of Biobrane (warning label on the product). The cause of the allergen is likely due to the cross-linking agent (dodecylamine) used to bond collagen peptides (gelatin) to the silicone surface. Collagen peptides on a skin substitute interact with the fibrin in the blood which is critical for early (acute) adherence (minutes). The present invention contains loosely incorporated collagen peptide sufficient to achieve early (acute) adherence but does not contain cross-linking agents (dodecylamine, cyanuric chloride, glutaraldehyde, etc.). As a result of eliminating cross-linking agents, the product of this invention will be safer for clinical use (non-allergic).

In addition to the materials previously mentioned, various forms of collagen have been used in the treatment of burns, see U.S. Pat. No. 3,491,760 which describes a “skin” made from two different tanned collagen gel layers.

U.S. Pat. No. 3,471,958 describes a surgical dressing made up of a mat of freeze dried microcrystalline collagen, while British Patent No. 1,195,062 describes the use of microcrystalline colloidal dispersions and gels of collagen to produce films which are then applied to various fibers such as polyurethane.

A “biolization” process for improvising the blood and biocompatibility of prosthetic devices has been described by Kambic, et al and others, see Trans. 3rd Annual Meeting Society for Biomaterials. Vol. 1, p. 42, 1977. Their methods involve deposition of gelatin into a rough textured rubber with subsequent cross-linking and stabilization of the gelatin with 0.45% gluteraldelyde.

Also of interest is U.S. Pat. No. 2,202,566 which describes collagen fibers in bandages and U.S. Pat. No. 3,113,568 which discloses the use of polyurethane foam in a bandage.

There are numerous references in the literature to various other materials used in burn treatment. For example, collagen membranes have been fabricated from suspensions of bovine skin and evaluated in a rat animal model. The adherence of this material was superior to auto- homo- and xenografts on full and split thickness wounds but inferior to auto- and homografts on granulating wounds, see Tavis et al. J. Biomed. Mater. Res. 9, 285 (1975) and Tavis et al, Surg. Forum 25, 39 (1974).

McKnight et al, developed a laminate of collagen foam with a thin polyurethane sheet, see U.S. Pat. No. 3,800,792. Film prepared from reconstituted collagen has also been used, Tavis et al, supra, and a commercially grade of such material is available from Tec-Pak Inc. Gourlay et al, Trans, Amer, Soc, Art, Int. Organs 21, 28 (1975) have reported the use of a silicone collagen composition, collagen sponge, and non-woven fiber mats.

Park, “Burn Wound Coverings—A Review”, Biomat, Med. Dev. Art. Org. 6(1), 1-35 (1978) contains a review, with extensive literature citations, of various burn wound coverings, including laminates of velour fabrics such as nylon, dacron (polyester), rayon, Teflon and polypropylene. Velour silicon rubber laminate are reported with the observation that Teflon and polypropylene velours could be easily peeled off the granulation bed. Rayon appeared to adhere well but disappeared after 10 to 14 days leaving only the silicone rubber backing. Dacron and nylon appeared to adhere well.

Nylon velour incorporating polypeptide films and polycaprolactone films were criticized because of cracking of the film. Ultra thin silicone fabric composite membranes have been reported by Kornberg et al, Trans. Amer. Soc. Artif. Int. Organs Vol. 18, pp. 39-44 1972.

In the literature reports of some of the above materials, adherence, continued elasticity and flexibility, and water vapor transmission appeared to emerge as important parameters in burn dressings. Thus, as far as burn wound coverings the following characteristics emerge as desirable:

1. The material must adhere to the wound base (comparable to auto- and homograft) to minimize infection and sepsis.

2. It must have adequate flexibility over a period of time in order to cover joints and other areas of body flexion.

3. It must have the proper moisture vapor transmission rate to maintain proper moisture balance at the wound site.

4. It should be capable of being easily stored, sterilized and available for use on short notice for emergency procedures.

5. It must not be toxic, pyrogenic, or antigenic.

6. It should be readily available at reasonable cost.

7. It must be capable of being applied to the wound site so as to completely isolate the site.

8. It must have sufficient strength to be secured by sutures, clips and the like.

In addition to the above, U.S. Pat. No. 3,846,353 describes the processing of silicone rubber with a primary or secondary amine, see also Canadian Pat. No. 774,529 which mentions ionic bonding of heparin on various prosthesis.

In addition to the above, there is considerable literature relating to the use of silicone rubber membranes Medical Instrumentation, Vol. 7, No. 4,268,275 September-October 1973; fabric reinforced silicone membranes, Medical Instrumentation, Vol. 9, No. 3,124,128, May-June 1975. U.S. Pat. No. 3,267,727 also describes the formation of ultra thin polymer membranes.

It is also known that various materials may be heparinized in order to impart a non-thrombogenic character to the surface of a material, see for example U.S. Pat. Nos. 3,634,123; 3,810,781; 3,826,678; and 3,846,353, and Canadian Pat. No. 774,529, supra.

Also present in the art are disclosures of bio- and blood compatible substrates through the use of biofunctional surfaces. For example, Ratner et al, J. Biomed. Mater. Res., Vol. 9, pp. 407-422 (1975) describes radiation-grafted polymers on silicone rubber sheets. U.S. Pat. Nos. 3,826,678 (Hoffman et al issued Jul. 30, 1974) and 3,808,113 (Okamura et al issued Apr. 30, 1974) describes the use of serum albumin and heparin as a biological coating, and collagen cross-linked by radiation. Collagen muco-polysaccharide composites are described by Yannas et al in U.S. Pat. No. 4,208,954 issued on Jul. 28, 1981 while Yannas et al U.S. Pat. No. 4,060,081 of Nov. 29, 1977 describes a multi-layered membrane for control of moisture transport in which cross-linked collagen and muco-polysaccharide is said to preclude immune response. Eriksson et al in U.S. Pat. No. 4,118,485 of Oct. 3, 1978 describes a non-thrombogenic surface using heparin.

Other prior art approaches are represented by the reported work of T. Miyata in Advances in Chemistry, No. 145, pp. 26-35 (1975); Japanese Patent No. Sho 46 (1971)-28193 and Kogaku No Ryoiki, Vol. 28(b) pp. 469-76 (1974). The Miyata work generally involves the use of collagen (tropo-collagen and tropocollagen with portions of the teleopeptides removed) and mucopolysaccharides (heparin and hyaluronic acid) to make or coat various products such as arterial prosthesis, kidney dialysis devices and hollow fiber tubing and the like.

It is also known to use a high molecular weight collagen fraction as a biological for an artificial heart. The biological is precipitated and then cross-linked to an irregular rubber surface using glutaraldehyde. The result is not a flexible coating in that the biologicals are covalently bonded to each other and are physically entrapped in apertures in the rubber.

### SUMMARY OF THE INVENTION

The methods for making the silicone/nylon composite membranes for the present invention are essentially the same as described in the 1989 patent.

The new procedures are

1) treating the silicone/nylon composite while still on a backing material with a laser beam to create precise holes of varying diameters and hole patterns and varying distances between holes.

The product (Biobrane) of the 1989 patent had 1.6 mm holes holes at ½ inch centers. The current invention will be better because of its ability to move exudate/blood through the invention; it will also be better able to transfer medicines through the more porous membrane to the wound surface.

2) A simple method for applying collagen peptides to the nylon and silicone surfaces without use of cross-linking agents. The collagen peptide (not bound) can freely interact with fibrin to achieve “acute adherence”.

3) Providing larger pieces of skin substitute to cover larger wounds without having to interleave the pieces.

4) The product and process of the 1989 patent to this inventor differ from the prior art by providing a composite elastomeric material from a thin film of polymeric material (e.g. silicone rubber) and a knitted or woven fabric (e.g. nylon). The polymeric component can be layered with high precision (final cured sample thicknesses with a tolerance of .+-.0.00025 inches). The fabric component is placed on the wet polymeric component (without wrinkles) and the composite is cured at a temperature of approximately 300 degrees. F. for 15-60 minutes. To this composite elastomeric matrix one or more biological molecules such as proteins (collagen, gelatin, fibrinogen, egg albumin, human albumin, human gamma globulin, or other animal or plant proteins), carbohydrates (acidic mucopolysaccharides, starch, simple sugars, etc.), lipids (lecithin, choline, unsaturated or saturated free fatty acids, other complex or simple lipids), amino acids (aspartic acid, lysine, glycine, serine, etc.), dipeptides (Glycylglycine, others), larger peptides and the like may be bonded using a number of commercially available reagents to accomplish either hydrophobic or covalent bonds.

The process can be thought of as a final product of composition A,B,C. The “A” represents the elastomeric fabricpolymeric composite matrix, which provides ideal physical properties (e.g. elasticity, conformability and water vapor transport properties). The “B” represents one or more components used to bond the “C” component (one or more biologicals) to the “A” component (fabricpolymeric composite metrics). The completed product A-B-C is used to impart a specific quality or a combination of characteristics of the material (A-B-C) to render them bio- and blood compatible.

The materials of the 1989 invention also exhibit a moisture vapor transmission rate, i.e. the weight of water lost by evaporation through a film membrane at 37 degree. C. over a period of 24 hours, of about 10-15 grams per hour per meter squared or about 1-1.5 milligrams per hour per centimeter squared, which is a rate similar to human skin, however, the WVT property of these materials are subject to modification to optimize wound healing.

Where used as a burn dressing, which is the principal but not the sole use of the materials of the 1989 invention, the material exhibits a moisture vapor transmission rate in the range indicated and, because of the inclusion of biological components, exhibit good adherence to the burn area. Thus, the materials of the present invention, used as a burn dressing preferably is in the form of a laminate including a thin film of a polymer, i.e., silicone rubber, urethane or other elastomeric polymer material, the film of polymer being of such dimensions and composition as to have a water vapor transmission rate in the range indicated. Physically bonded to the thin polymer film is a thin porous fabric such that the composite is elastic in all directions, i.e. length and width. Covalently coupled to one or both sides of the laminate is one or more biological materials to provide adherence and compatibility to the wound site.

Regardless of the form of the substrate, sheet, tube, formed contour and the like, the biological compound is bound by treating the substrate with a primary or secondary amine such that the amino groups are available for further reaction. In one form this is accomplished by incorporating the primary or secondary amine into the substrate such that the amino functional groups extend out of the surface as coupling sites. In another form, the substrate is coated with a primary or secondary amine silating agent in order to provide terminal available amino functional groups, again as coupling sites.

The first form above described is similar in part to the procedure described in U.S. Pat. No. 3,634,123 and the primary and secondary amines there disclosed may be used in this form of the present invention.

The second form above described offers the advantage of being able to provide available amino groups reactive sites with a variety of substrates both of organic and inorganic character, i.e. substrates other than silicone urethane, for example other polymers to which the material will adhere to, or to inorganics such as metal or glass.

The procedure described in the 1989 invention is distinguishable from those of U.S. Pat. No. 3,846,353 which use as a long chain alkyl quaternary ammonium salt to ionically bind heparin to various polymer substrates.

According to the 1989 invention, the available amino functional groups are then activated for bonding to a biological. This is in contrast to U.S. Pat. No. 3,634,123 in which heparin is ionically linked to the positively charged amine directly, or in contrast to U.S. Pat. No. 3,810,781 which treats the substrate-amine hydrochloride-heparin salt subsequently with a dialdehyde, such as glutaraldehyde, to stabilize the heparin on the substrate surface.

Activation of the amino groups, according to the 1989 invention may be accomplished by one of several ways. In one form dialdehyde, such as glutaraldehyde, is reacted with the primary or secondary amine provided by either of the procedures described, leaving available aldehyde groups average of one per molecule of glutaraldehyde for subsequent reaction with the primary or secondary amines of either proteins, mucopolysaccharides or other amine containing biologicals. In another form, the preferred form, cyanuric chloride is reacted with the primary and secondary amines provided on the substrate as previously described. The available chloride groups of cyanuric chloride may then be used to react with the primary or secondary amines or hydroxyl groups of various biologicals to form covalent bonds.

Other bifunctional reagents that may be used to link substrate amines with biological amines are thiophosgenes, isocyanates, derivitized cyanuric chloride (one C1 group removed or alkylated), 1,5-difluoro-2,4-dinitrobenzene, diazobenzidine, toluene-2,4-diisothiocyanates and others.

Thus, a wide variety of new, improved and relatively simple procedures are described for attaching various biologicals on a substrate which, in accordance with this invention, may be used as burn covering having the desirable properties mentioned.

It will be apparent from the following detailed description and specific examples and data that a much improved bio- and blood compatible material has been provided by a relatively simple and reliable procedure. The further advantages and features may be understood with reference to the following description of the invention.

### DETAILED DESCRIPTION OF THE INVENTION

The present invention is a laser-perforated, temporary skin substitute having a wide range of perforations (hole diameter and hole pattern density). Typical hole diameters are about 0.75 mm to about 1.05 mm; and hole density patterns from about 0.061″ apart to about 0.5″ apart. Other suitable hole densities are about 0.25″ apart or about 0.33″ apart.

The structure of the temporary skin substitute consists of a silicone elastomer which is cured in contact with a finely knitted nylon fabric. Typically the cured thickness of the silicone elastomer component is about 0.001″ thick. The fabric thickness is about 0.006″ thick (12/1 denier material) or 0.010″ thick (15/1 denier material). Suitable conditions for making this silicone elastomer/nylon composite material are described in Applicant's U.S. Pat. Nos. 4,820,302 and 4,820,561 (the prior invention), supra, and incorporated herein by reference.

The laser formed perforations of this invention may also be employed in skin substitutes other than this invention to substantially improve porosity. The laser perforations are possible only after the silicone component has been cured. Needle perforations are not possible after the silicone has been cured (when the needle is removed from cured silicone, the hole collapses). Other technologies could be used to burn holes in a cured silicone material; however, laser technology is preferred.

Carbon dioxide laser (CO2) laser) operating in continuous or semi-continuous mode, emitting a wave of 10.6 micrometers, or in a range of 9.4 o 9.6 micrometers, or on several of these defined wavelengths simultaneously. These CO2 lasers operate at a power level between 1 and 100 watts, typically 5 to 20 watts.

Table 1 shows successful results from laser drilling as described above. The table displays the hole sizes produced using two separate methods: 1) stretching the material over an open space and using lower power to try to remove the silicone without damaging the nylon fiber, and 2) leaving the material on the backing material and using a lightly higher power to machine through the nylon and silicon to create a completely clear hole.

TABLE 1
CO2 Laser Drilling Results

| | Method | | | Programmed |
|---|---|---|---|---|
| Sample | Used | Material ID | Power in W | Hole Size in mm |
| 1 | 1 | Jan. 26, 2008 | 2.5 | 1.4 |
| 2 | 1 | Jan. 26, 2008 | 2.25 | 1.4 |
| 3 | 2 | Feb. 14, 2008 | 11.25 | 1 |
| 4 | 2 | Feb. 14, 2008 | 12.5 | 1 |
| 5 | 2 | Feb. 14, 2008 | 12.5 | 1 |
| 6 | 2 | Feb. 8, 2008 | 12.5 | 1 |
| 7 | 2 | Feb. 8, 2008 | 15 | 1 |
| 8 | 2 | Feb. 8, 2008 | 17.5 | 1 |
| 9 | 1 | Feb. 8, 2008 | 3 | 1.4 |
| 10 | 1 | Feb. 8, 2008 | 3.75 | 1.4 |

The CO2 lasers are scanned across the material by means of a galvanometer-based or polygon-based scanning system, or a combination of the two. The scanning can also be done in combination with linear movement of the polymer material, done by a linear stage or reel-to-reel transport mechanism, such that the relative movement between the laser and the material is in the range 50 to 5000 millimeters, typically 1000 to 2000 millimeters.

To minimize potential localized heat damage to the material, a special scan sequence and scan profile is designed. While hole drilling is performed, the material is held free from any backing plate, so that any laser radiation not absorbed by the material passes away freely.

Nylon knitted with 12/1, 15/1, 15/3 and 18/3 filaments are possible. Preferred filaments are 12/1 and 15/1 denier nylon filament.

Nylon sheets can be fabricated larger than 2′ square using a Santoni SM8 machine that produces a Jersey Stitch weave and a thread count typically in the range of 15-35 threads/cm. Sizes up to four square feet can be produced reliably.

Collagen peptide is applied with a Parsche microfine airbrush to the nylon surface in the following manner: a saturated and filtered solution of VSH Porcine gelatin 100 mesh, 300 bloom is placed into the spray cup; airbrush pressure is set 1 psi; airbrush is held 12-14 inches from the material (nylon side facing the airbrush) and sprayed uniformly onto the surface such that the amount of peptide deposited is in the range of 3-10 micrograms per square centimeter of surface area; the silicon/nylon composite with deposited collagen peptide is dried at room temperature

The primary use of said invention is for clean superficial burns that have been debrided of all eschar and nonviable tissue. The skin substitute is held in place with pressure dressings to optimize early adherence. Benefits of this skin substitute are: excellent early and late adherence (primary characteristic of a successful temporary or permanent skin substitute), control of fluid loss (comparable to normal skin), minimize infection beneath the skin substitute, translucent to enable the clinician to observe the wound during the healing process, be stretchable and flexible to facilitate aggressive rehabilitation, minimize pain by eliminating exposed nerves to air, minimize dressing changes (always traumatic to the patient), and maximize wound healing rates. Other wounds where this temporary skin substitute will be effective are: donor sites, coverage of excised deep burns until autograft is available, covering meshed autograft until the interstices have healed other clean wounds where there is minimal dead tissue and the bacterial counts are less than 100,000 microbes per gram of tissue.

The preferred method of sterilization of the present invention is exposure to 41 kGy dose of electron beam radiation. Under these conditions, the physical and chemical properties of the present invention are not compromised.

Conceptually the improved and novel products of the prior invention, produced by the improved and novel process of this invention, include a suitable substrate treated to provide available and reactive primary or secondary amine functional reactive sites. The amine functional sites are then activated either by reaction with a dialdehyde, or preferably cyanuric chloride to provide available active aldehyde or arylchloride groups, respectively. Thereafter, one or more biological materials, as previously described, having a hydroxyl, primary or secondary amine, is then coupled to the available free aldehyde or arylchloride group. In this way select biologicals are covalently coupled to the substrate in an amount and in a form sufficiently stable to provide bio- and blood compatibility to the substrate.

The useable substrates may be a wide variety of materials depending upon the procedure and to provide available primary and secondary amine functional reactive sites. For example, a reactive silicone containing a primary or secondary amine may be used as a primer and coated on the substrate to provide the reactive amine group. Such a procedure is described in Canadian Pat. No. 774,529, however, the amine is then alkylated to form a positively charged quaternary ammonium salt which is then used to ionically bind heparin to the surface of the substrate.

Thus, typical substrates are glass, and the elastomers, silicone rubbers and polymers used in medical applications. Representatives of such materials are:

silicone rubbers and elastomer polysiloxanes, natural rubber, polybutadiene, styrene-butadiene, butyl rubber,

for example;

polymers such as polyethylene, polypropylene polystyrene, polyvinylchlorides, polyvinyl acetate, ethacrylate and methacrylate polymers and copolymers and the like.

For wound dressings it is preferred to use silicone rubbers of membrane thickness as will be described.

A useable primer is an aminofunctional silane coupling agent such as gamma(beta-aminoethyl)aminopropyltrimethoxysilane, available as Dow Corning Z-6020. This primer also bonds well to materials such as nylon, dacron and the like, the latter may optionally be components of the substrate, as will be apparent with the description of burn wound dressings and the prosthesis to be described. Another material which may be used is an amino-functional silane, e.g. aminoalkylsilanes such as gamma-aminopropyltriethoxysilane. Such a material is commercially available from Union Carbide Corporation under the designation Union Carbide A-1100. Other aminofunctional silanes are also well known in the art such as aminoalkylsilanes, for example, gamma-aminopropyltriethoxysilane, gamma-aminopropyltrimethoxysilane, N-beta-(aminoethyl)-gamma-aminopropyltrimethoxysilane, N′-(beta-aminoethyl)-N-(beta-aminoethyl)-gamma-aminopropyltrimethoxysilane, to mention only a few.

Other materials which may be used include hydroxyfunctional silanes, mercapto-functional silanes and other silanes which may react with the substrate at one end of the silane (through an alkoxy group for example) and the other end of which may be coupled to the biological.

In an alternate embodiment of the present invention, needles of various diameters arrayed in a regular or random pattern can be used to pierce the substrate to produce the pore holes, following the cure cycle of substrate production. Typical hole diameters are similar to those produce by the above-described laser drilling process, about 0.75 mm to about 1.05 mm; and hole density patterns from about 0.061″ apart to about 0.5″ apart. This is a new and different result than those obtained by piercing the substrate during the curing process.

It will, accordingly, be apparent to those skilled in the art that various alternations, changes and modifications may be made with respect to the products and procedures herein described without departing from the scope of the present invention as set forth in the appended claims.

1. A method for treating a bio and blood compatible substrate wherein said substrate is a material which includes at least a surface portion which is a silicone elastomer which is cured in contact with a finely knitted nylon fabric, comprising the steps of:
obtaining a thin, flat piece of said substrate,
drilling holes through said substrate with a drilling means, said hole diameters approximately 0.75 mm to 1.05 mm and the density patterns of said holes from about 0.061″ apart to about 0.5″ apart, said holes distributed in a pattern type selected from random or regular,
curing said substrate with a curing means to harden said substrate.

2. A method for treating a bio and blood compatible substrate as in claim 1 wherein said drilling means is a laser drill with variable width aperture.

3. A method for treating a bio and blood compatible substrate as in claim 1 wherein said random pattern type is a pseudo-random pattern generated by a computer program.

4. A method for treating a bio and blood compatible substrate as in claim 1 wherein the bio and blood compatible substrate is fabricated in sizes up to four square feet in area.

5. A method for treating a bio and blood compatible substrate as in claim 1 where the drilling means is a plurality of needles of various diameters, said needles used to pierce said substrate after the curing phase of said substrate.
